(19) United States
(12) Patent Application Publication
(10) Pub. No.: US 2021/0125800 A1
(43) Pub. Date: Apr. 29, 2021

(54) PUSH SWITCH

(71) Applicant: MITSUMI ELECTRIC CO., LTD., Tokyo (JP)

(72) Inventor: Seigo OTAKA, Tokyo (JP)

(21) Appl. No.: 17/066,317

(22) Filed: Oct. 8, 2020

(30) Foreign Application Priority Data
Oct. 24, 2019 (JP) 2019-193774

(51) Int. Cl. H01H 13/48; H01H 13/52; H01H 13/06

(52) U.S. Cl. CPC H01H 13/48; H01H 13/06; H01H 13/52

(57) ABSTRACT

A push switch includes a case having a containable portion defined by a bottom plate and a wall portion, a central contact provided on the bottom plate, an outer contact provided on the bottom plate so as to be spaced from the central contact in the containable portion, a movable contact disposed above the central contact and the outer contact, a cover film disposed so as to cover the containable portion, and a disc-shaped pressing member provided between the movable contact and the cover film. By pressing the pressing member downward, the movable contact is displaced from a first position to a second position. A diameter R of the pressing member is in the range of 30 to 45% of the width in the longer side direction of the movable contact and in the range of 45 to 60% of the width in the shorter side direction of the movable contact in a plan view.

### CROSS-REFERENCE TO RELATED APPLICATION

This application claims priority to Japanese Patent Application No. 2019-193774, filed on Oct. 24, 2019 (entitled “Push Switch”), the contents of which are hereby fully incorporated by reference.

### TECHNICAL FIELD

The present invention generally relates to push switches, in particularly to a push switch that operates with a click feeling by a pressing operation.

### BACKGROUND

As an operation button of an electronic device such as a smartphone (e.g., power button, volume adjustment button, etc.), a push switch utilizing a dome-shaped movable contact is often employed. Such a push switch is capable of downsizing and reducing a height thereof, and when the operation button is operated by a pressing operation by a user, it is possible to provide a good click feeling (pushing operation feeling) to the user.

For example, Patent Document 1 discloses a push switch 500 as shown in FIGS. 1 and 2. FIG. 1 is a perspective view of a push switch 500, and FIG. 2 is a longitudinal sectional view of the push switch 500. As shown in FIGS. 1 and 2, the push switch 500 includes a case 510 having a containable portion 513 defined by a bottom plate 511 and a wall portion 512 extending upward from the bottom plate 511, a central contact 520 provided on the bottom plate 511 of the case 510, an outer contact 530 provided on the bottom plate 511 of the case 510 so as to surround the central contact 520, a dome-shaped movable contact 540 provided above the central contact 520 and the outer contact 530 in the containable portion 513 of the case 510, a cover film 550 covering the containable portion 513 of the case 510, and a pressing member 560 provided between the movable contact 540 and the cover film 550.

When the user pushes the pressing member 560 downward through the cover film 550, the central portion of the dome-shaped movable contact 540 is elastically deformed downward and thus the central portion of the movable contact 540 is in contact with the central contact 520. Since the periphery portion of the movable contact 540 is in contact with the outer contact 530, when the central portion of the movable contact 540 is in contact with the central contact 520, the central contact 520 and the outer contact 530 become a conductive state. On the other hand, when the pressing force applied by the user is released, the central portion of the movable contact 540 is elastically restored and thus the central portion of the movable contact 540 is spaced apart from the central contact 520. As a result, the central contact 520 and the outer contact 530 become a non-conductive state.

In such a dome-shaped movable contact 540, when the central portion of the movable contact 540 is elastically deformed downward beyond a predetermined threshold value determined by the material and shape of the movable contact 540, the resistance of the movable contact 540 against the downward pressing force suddenly decreases. Therefore, by using the dome-shaped movable contact 540, it is possible to provide a good click feeling to the user.

Further, by providing a disk-shaped pressing member 560 between the cover film 550 and the movable contact 540, it is possible to more elastically deform the movable contact 540 largely, and thus it is possible to provide a better click feeling to the user. For this reason, a push switch that utilizes a dome-shaped movable contact is often employed as an operation button of an electronic device such as a smartphone.

On the other hand, with the miniaturization of electronic devices in recent years, as described above, there is an increasing need for further miniaturization for push switches used as operation buttons of electronic devices. While the push switch needs to be miniaturized, the operating force of the push switch (the pressing force required to operate the push switch) needs to be a certain level or more. This is because, if the operating force of the push switch is small, the push switch may operate due to slight pressing force when the electronic device is placed in a pocket or when the electronic device contacts some objects, thereby causing malfunction of the push switch.

In order to cope with such a problem, Patent Document 2 discloses a push switch which is used in a state in which a plurality of movable contacts are stacked on each other. By using such a push switch in a state of stacking a plurality of movable contacts, while reducing the size of the movable contact, it is prevented that the operating force of the push switch is reduced.

Thus, with the miniaturization of the push switch, although the movable contact is miniaturized, the sum of the spring load of the movable contact to be pressed by the pressing member (resistance to the pressing force downward) is not reduced. Therefore, with the miniaturization of the push switch, it is impossible to simply reduce the size of the pressing member. If the size of the pressing member with respect to the movable contact is too small, the pressing member will collapse during pressing and thus it is impossible to operate the push switch. On the other hand, if the size of the pressing member with respect to the movable contact is too large, the pressing force applied to the movable contact will be scattered, and thus it is impossible to provide a good click feeling to a user. For this reason, there is a need for a push switch that can provide a favorable click feeling to a user even when it is miniaturized.

### RELATED ART DOCUMENTS

### Patent Documents

JP 2013-58380A

JP 2014-220039A

### SUMMARY

### Problem to be Solved by the Invention

It is an object of the present invention to provide a push switch capable of providing a favorable click feeling to a user even in the case of being miniaturized.

### Means for Solving the Problem

The above object is achieved by the present inventions defined in the following (1) to (10).

(1) A push switch, comprising:

a case having a containable portion defined by a bottom plate and a wall portion extending upward from the bottom plate;

a central contact provided on the bottom plate in the containable portion;

an outer contact provided on the bottom plate in the containable portion so as to be spaced apart from the central contact;

a dome-shaped movable contact having a substantially rectangular and planner shape that can be displaced in the containable portion between a first position disposed above the central contact and the outer contact in which the central contact and the outer contact are in a non-conductive state and a second position in which the central contact and the outer contact are in a conductive state;

a cover film disposed above the movable contact so as to cover the containable portion; and

a disc-shaped pressing member disposed on the movable contact so as to displace the movable contact from the first position to the second position by pushing the movable contact downwardly,

wherein a diameter of the pressing member is in the range of 30 to 45% of the width of the movable contact in the longer side direction thereof in a planner view, and in the range of 45 to 60% of the width of the movable contact in the shorter side direction thereof in the planner view.

(2) The push switch according to the above (1), wherein the movable contact is in contact with the outer contact in both the first position and the second position, and when the movable contact takes the first position, the movable contact is not in contact with the central contact, but when the movable contact takes the second position, the movable contact is in contact with the central contact, and

wherein in the containable portion of the case, a contact surface of the central contact which is in contact with the movable contact when the movable contact takes the second position is located lower than a contact surface of the outer contact which is in contact with the movable contact.

(3) The push switch according to the above (2), wherein the bottom plate of the case has a concave portion formed in a substantially central portion of the bottom plate, and a bottom plate stepped portion located outside the concave portion, wherein an upper surface of the concave portion is lower than an upper surface of the bottom plate stepped portion.

(4) The push switch according to the above (3), wherein the central contact is embedded in the bottom plate of the case so that the contact surface of the central contact is the same height as the upper surface of the concave portion of the bottom plate of the case, and

wherein the outer contact is embedded in the bottom plate of the case so that the contact surface of the outer contact is the same height as the upper surface of the bottom plate stepped portion of the bottom plate.

(5) The push switch according to any one of the above (1) to (4), wherein the cover film is welded to an upper surface of the wall portion of the containable portion of the case so as to seal the containable portion of the case in a liquid-tight manner.

(6) The push switch according to any one of the above (1) to (5), further comprising one or more intermediate movable members provided between the movable contact and the pressing member, wherein each of the one or more intermediate movable members is made of the same material as the movable contact and has the same shape as the movable contact.

(7) The push switch according to the above (6), wherein a spring load of each of the one or more intermediate movable members is equal to a spring load of the movable contact.

(8) A push switch, comprising:

a case having a containable portion defined by a bottom plate and a wall portion extending upward from the bottom plate;

a central contact provided on the bottom plate in the containable portion;

an outer contact provided on the bottom plate in the containable portion so as to be spaced apart from the central contact;

a dome-shaped movable contact having a substantially rectangular and planner shape that can be displaced in the containable portion between a first position disposed above the central contact and the outer contact in which the central contact and the outer contact are in a non-conductive state and a second position in which the central contact and the outer contact are in a conductive state;

a cover film disposed above the movable contact so as to cover the containable portion;

a disc-shaped pressing member disposed on the movable contact so as to displace the movable contact from the first position to the second position by pushing the movable contact downwardly; and

one or more intermediate movable members provided between the movable contact and the pressing member,

wherein a diameter of the pressing member is in the range of 30 to 45% of the width of the movable contact in the longer side direction thereof in a planner view, and in the range of 45 to 60% of the width of the movable contact in the shorter side direction thereof in the planner view.

(9) The push switch according to the above (8), wherein each of the one or more intermediate movable members is made of the same material as the movable contact and has the same shape as the movable contact,

the one or more intermediate movable members are stacked above the movable contact, and

each of the movable contact and the intermediate movable members has a central movable portion formed in a substantially central part thereof in a planner view and an outer periphery portion formed so as to surround the central movable portion.

(10) The push switch according to the above (9), wherein the outer periphery portion of the movable contact is in contact with the outer contact in both the first position and the second position, and when the movable contact takes the first position, the central movable portion of the movable contact is not in contact with the central contact, but when the movable contact takes the second position, the central movable portion of the movable contact is in contact with the central contact, and

wherein in the containable portion of the case, a contact surface of the central contact which is in contact with the central movable portion of the movable contact when the movable contact takes the second position is located lower than a contact surface of the outer contact which is in contact with the outer periphery portion of the movable contact, and

wherein when the movable contact is in the second position, the central movable portion of the intermediate movable member which is located at least the uppermost position among the intermediate movable members is located at a position lower than the outer periphery portion of the uppermost intermediate movable member.

### Effect of the Invention

According to the present invention, even when the push switch is miniaturized, it is possible to provide a good click feeling to the user.

### BRIEF DESCRITION OF THE FIGURES

FIG. 1 is a perspective view of a conventional push switch.

FIG. 2 is a longitudinal sectional view of the conventional push switch shown in FIG. 1.

FIG. 3 is a perspective view of a push switch according to an embodiment of the present invention.

FIG. 4 is an exploded perspective view of the push switch shown in FIG. 3.

FIG. 5 is a perspective view of the central contact and the outer contact shown in FIG. 4.

FIG. 6 is a longitudinal sectional view of the case, the central contact and the outer contact shown in FIG. 4.

FIG. 7 is a plan view for explaining the relationship between the size of the pressing member and the size of the movable contact shown in FIG. 4.

FIG. 8 is a longitudinal sectional view of the push switch when the push switch shown in FIG. 3 is in a natural state.

FIG. 9 is a longitudinal sectional view of the push switch when the push switch shown in FIG. 3 is in a depressed state.

FIG. 10 is a graph showing the feeling curve of the push switch shown in FIG. 3.

FIG. 11 is a plan view of a push switch according to an embodiment of the present invention.

FIG. 12 is a bottom view of the push switch according to the embodiment of the present invention.

FIG. 13 is a front view of the push switch according to the embodiment of the present invention.

FIG. 14 is a rear view of the push switch according to the embodiment of the present invention.

FIG. 15 is a left side view of the push switch according to the embodiment of the present invention.

FIG. 16 is a right side view of the push switch according to the embodiment of the present invention.

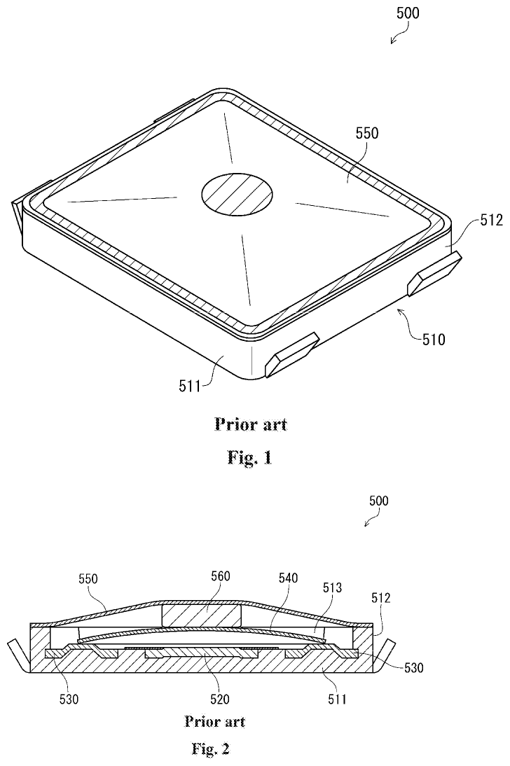

### DETAILED DESCRIPTION OF THE PREFERRED EMBODIMENTS

Hereinafter, description will be given to a push switch of the present invention based on a preferred embodiment shown in the accompanying drawings. In this regard, the drawings referenced in the following description are schematic views prepared for explaining the present invention. A dimension (such as a length, a width and a thickness) of each component shown in the drawings is not necessarily identical to an actual dimension. Further, the same reference numbers are used throughout the drawings to refer to the same or like elements. In the following description, the positive direction of the Z-axis of each figure is referred to as “upper side”, the negative direction of the Z-axis is referred to as “lower side”, the positive direction of the Y-axis is referred to as “front side”, the negative direction of the Y-axis is referred to as “back side”, the positive direction of the X-axis is referred to as “right side”, and the negative direction of the X-axis is referred to as “left side” on occasions.

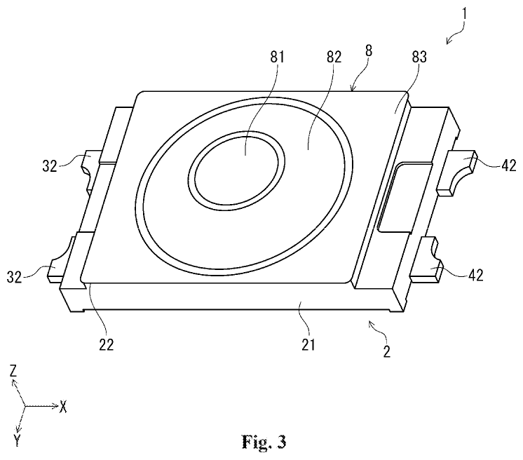

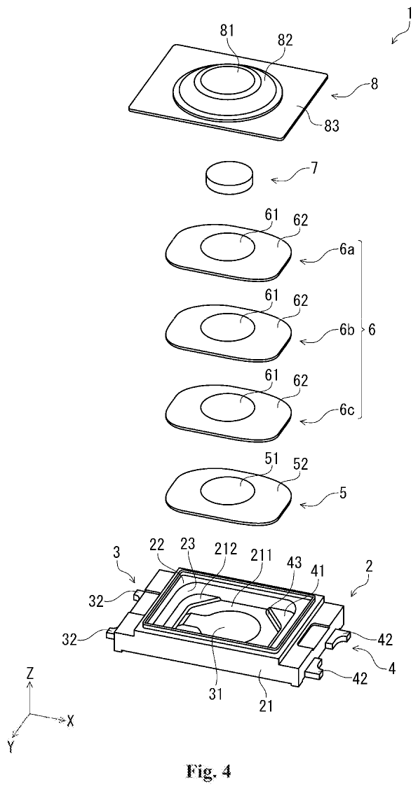

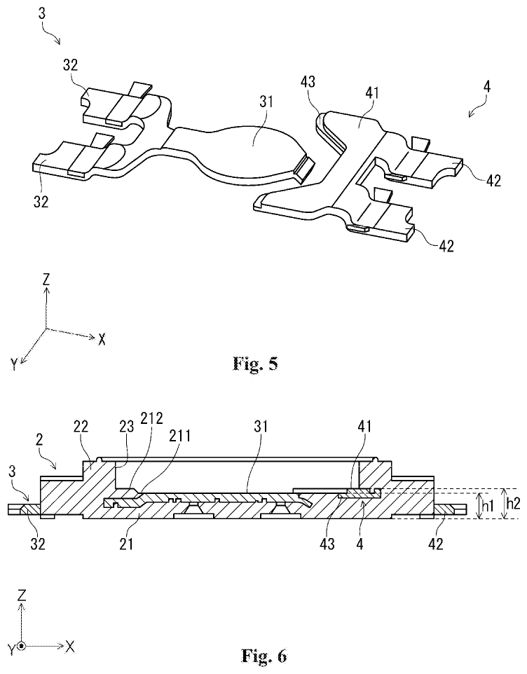

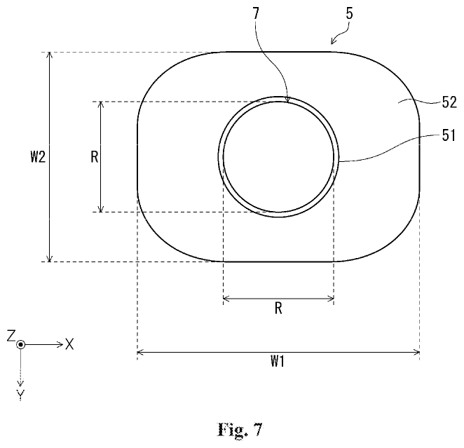

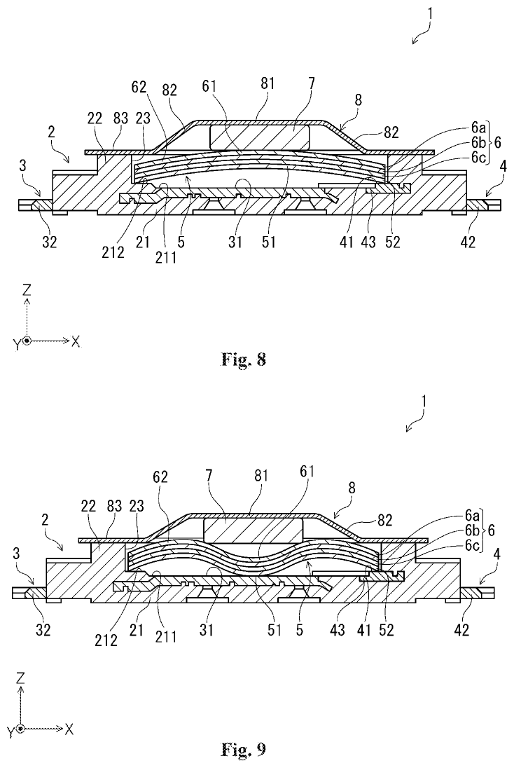

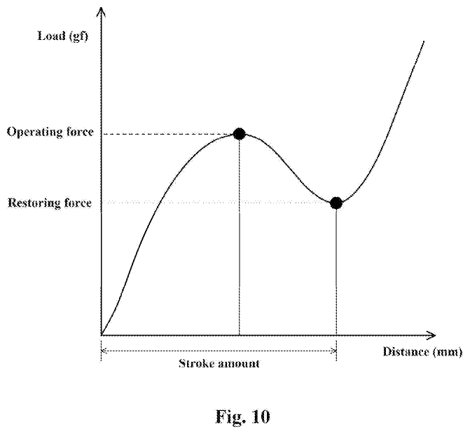

Hereinafter, the push switch of the present invention will be described in detail with reference to FIGS. 3 to 10. FIG. 3 is a perspective view of a push switch according to an embodiment of the present invention. FIG. 4 is an exploded perspective view of the push switch shown in FIG. 3. FIG. 5 is a perspective view of the central contact and the outer contact shown in FIG. 4. FIG. 6 is a longitudinal sectional view of the case, the central contact and the outer contact shown in FIG. 4. FIG. 7 is a plan view for explaining the relationship between the size of the pressing member and the size of the movable contact shown in FIG. 4. FIG. 8 is a longitudinal sectional view of the push switch when the push switch shown in FIG. 3 is in a natural state. FIG. 9 is a longitudinal sectional view of the push switch when the push switch shown in FIG. 3 is in a depressed state. FIG. 10 is a graph showing the feeling curve of the push switch shown in FIG. 3.

The push switch 1 according to the embodiment of the present invention shown in FIG. 3 is a switch that is turned on when a pressing force exceeding the operating force of the push switch 1 is applied from the user, and is turned off when the pressing force applied from the user is released. Typically, the push switch 1 is used as an operation button of a small electronic device such as a smart phone, a power button or a volume adjustment button, for example.

As shown in FIG. 3, the push switch 1 has a low-height rectangular parallelepiped-shaped overall shape. The push switch 1 is very small, for example, having dimensions of about 3.0 mm (total length in the X-axis direction) X about 1.5 mm (total length in the Y-axis direction) X about 0.5 mm (total height in the Z-axis direction). The push switch 1 is configured such that the operating force of the push switch 1, that is, the pressing force required to turn on the push switch 1 is about 300 gf or more. By setting the operating force of the push switch 1 to about 300 gf or more, the push switch 1 is prevented from unintentionally operating due to a slight pressing force when the electronic device including the push switch 1 is placed in a pocket or when the electronic device including the push switch 1 comes into contact with an object.

As shown in FIG. 4, the push switch 1 includes a case 2 having a containable portion 23 defined by a bottom plate 21 and a wall portion 22 extending upward from the bottom plate 21, a central contact 3 provided on the bottom plate 21 in the containable portion 23, an outer contact 4 provided spaced from the central contact 3 in the containable portion 23, a dome-shaped movable contact 5 having a substantially rectangular and planner shape that can be displaced in the containable portion 23 between a first position disposed above the central contact 3 and the outer contact 4 in which the central contact 3 and the outer contact 4 are in a non-conductive state (see FIG. 8) and a second position in which the central contact 3 and the outer contact 4 are in a conductive state (see FIG. 9), one or more intermediate movable members 6 provided on the movable contact 5 in a stacked manner, a disc-shaped pressing member 7 that can displace the movable contact 5 from the first position to the second position by pushing the movable contact 5 downwardly, and a cover film 8 made of a flexible resin material and disposed above the movable contact 5, the intermediate movable members 6 and the pressing member 7 so as to cover the containable portion 23.

The case 2 is a box-shaped member formed of an insulating resin and opened upward. The case 2 includes the bottom plate 21, the wall portion 22 extending upward from the outer peripheral portion of the bottom plate 21, and the containable portion 23 defined by the upper surface of the bottom plate 21 and the inner surface of the wall portion 22.

The bottom plate 21 is a plate-like member having a substantially rectangular and planner shape, and functions as a substrate of the push switch 1. As shown in FIG. 4, in the substantially central part of the upper surface of the bottom plate 21, a concave portion 211 is formed. Further, in the left end side of the upper surface of the bottom plate 21 in the containable portion 23, a bottom plate stepped portion 212 is formed. On the other hand, in the right end side of the upper surface of the bottom plate 21 in the containable portion 23, a contact surface 41 and a thinner thickness part 43 of the outer contact 4 are located. Due to the bottom plate stepped portion 212 formed on the upper surface of the bottom plate 212 and a stepped portion toward the contact surface 41 from the thinner thickness part 43 of the outer contact 4, the concave portion 211 is defined. Further, as shown in this figure, the upper surface of the concave portion 211 is positioned lower than the upper surface of the bottom plate stepped portion 212 and the contact surface 41 of the outer contact 4.

The wall portion 22 extends upward from the four outer peripheral portions of the bottom plate 21, and is formed integrally with the bottom plate 21. The containable portion 23 is formed into a concave shape which opens upward and is defined by the upper surface of the bottom plate 21 and the inner surfaces of the wall portion 22. Each component of the push switch 1 is contained in the containable portion 23. Thus, the case 2 has a function as a housing for containing each component of the push switch 1 in the containable portion 23.

The case 2 holds the central contact 3 and the outer contact 4 in a state of being insulated from each other. The case 2 is obtained by disposing the center contact 3 and the outer contact 4 in a mold having an inner shape corresponding to the shape of the case 2, injecting an insulating resin into the mold, and curing the resin.

FIG. 5 is a perspective view of the central contact 3 and the outer contact 4 held by the case 2. Further, FIG. 6 is a longitudinal sectional view of the case 2 in a state of holding the central contact 3 and the outer contact 4. Each of the central contact 3 and the outer contact 4 is formed of a conductive material, more specifically, a metallic material such as copper. The central contact 3 and the outer contact 4 are held in a state of being insulated from each other in the containable portion 23 of the case 2, and function as fixed electrodes.

Each of the central contact 3 and the outer contact 4 is obtained by punching and bending a single metal plate. The central contact 3 includes a contact surface 31 to be in contact with the movable contact 5 and a pair of terminal portions 32 extending to the outside of the case 2. The outer contact 4 includes the contact surface 41 to be in contact with the movable contact 5, the pair of terminal portions 42 extending to the outside of the case 2, and the thinner thickness portion 43 formed on the distal end side of the contact surface 41.

The contact surface 31 of the central contact 3 is exposed upward in the containable portion 23 of the case 2, and when the movable contact 5 takes the second position, the contact surface 31 is in contact with the movable contact 5. The pair of terminal portions 32 extend from the left side of the case 2 toward the outside, and function as external terminals to be connected to the circuit board of the electronic device.

The contact surface 41 of the outer contact 4 is exposed upward in the containable portion 23 of the case 2, and the contact surface 41 is a surface in contact with the movable contact 5 even when the movable contact 5 takes either of the first position and the second position. The pair of terminal portions 42 extend from the right side of the case 2 toward the outside, and function as external terminals to be connected to the circuit board of the electronic device. The thinner thickness portion 43 is formed at the left end of the contact surface 41, and the height of the thinner thickness portion 43 is lower than the height of the contact surface 41. The concave portion 211 of the bottom plate 21 is defined by the inner surfaces of the stepped portion from the thinner thickness portion 43 toward the contact surface 41 and the bottom plate stepped portion 212 formed on the bottom plate 21 of the case 2.

As shown in FIG. 4, the contact surface 31 of the central contact 3 is exposed upward substantially in the center of the concave portion 211 formed in the bottom plate 21 of the case 2. On the other hand, the contact surface 41 of the outer contact 4 is exposed upward in the right portion of the bottom plate 21 of the case 2.

As shown in FIG. 6, the central contact 3 is embedded in the bottom plate 21 of the case 2 so that the height of the contact surface 31 becomes the same height as the upper surface of the concave portion 211 of the bottom plate 21 of the case 2 in the containable portion 23 of the case 2. In this connection, it is to be noted that the language “the height of the contact surface 31 becomes the same height as the upper surface of the concave portion 211 of the bottom plate 21 of the case 2” includes the case that the difference between the height of the upper surface of the contact surface 31 and the height of the upper surface of the concave portion 211 of the bottom plate 21 of the case 2 lies within the manufacturing tolerance occurring during the manufacture of the push switch 1 (for example, even if it is about a few percent) in addition to the case that the height of the contact surface 31 is exactly the same height as the upper surface of the concave portion 211 of the bottom plate 21 of the case 2.

On the other hand, the outer contact 4 is embedded in the bottom plate 21 so that the height of the contact surface 41 becomes the same height as the upper surface of the bottom plate stepped portion 212 of the bottom plate 21 of the case 2 in the containable portion 23 of the case 2. In this connection, it is to be noted that the language “the height of the contact surface 41 becomes the same height as the upper surface of the concave portion 211 of the bottom plate 21 of the case 2” includes the case that the difference between the height of the upper surface of the contact surface 41 and the height of the upper surface of the bottom plate stepped portion 212 of the bottom plate 21 of the case 2 lies within the manufacturing tolerance occurring during the manufacture of the push switch 1 (for example, even if it is about a few percent) in addition to the case that the height of the contact surface 41 is exactly the same height as the height of the upper surface of the bottom plate stepped portion 212. Further, as shown in FIG. 5, in the containable portion 23 of the case 2, the contact surface 41 and the thinner thickness portion 43 of the outer contact 4 are spaced apart from the contact surface 31 of the central contact 3 with keeping a predetermined distance on the right side of the contact surface 31 of the central contact 3.

Referring back to FIG. 6, the height h1 from the bottom surface of the bottom plate 21 of the case 2 to the contact surface 31 of the central contact 3 is lower than the height h2 from the bottom surface of the bottom plate 21 of the case 2 to the contact surface 41 of the outer contact 4. Therefore, in the containable portion 23 of the case 2, the contact surface 31 of the central contact 3 is positioned lower than the contact surface 41 of the outer contact 4.

Thus, in the push switch 1 of the present invention, the concave portion 211 is formed on the upper surface of the bottom plate 21 of the case 2, and the central contact 3 is embedded in the bottom plate 21 of the case 2 so that the contact surface 31 of the central contact 3 becomes the same height as the upper surface of the concave portion 211 of the bottom plate 21 of the case 2, thereby lowering the position of the contact surface 31 of the central contact 3. With such a configuration, it is possible to increase the downward stroke amount of the movable contact 5.

Since the push switch 1 of the present invention is a very small and has a low height, it is impossible to secure the height of the wall portion 22 of the case 2 and thus the depth of the containable portion 23 of the case 2 becomes shallow. If the depth of the containable portion 23 is not sufficient, it is difficult to secure the downward stroke amount of the movable contact 5. If the downward stroke amount of the movable contact 5 is small, the click feeling when the user presses the push switch 1 is impaired.

Therefore, in the push switch 1 of the present invention, by lowering the position of the contact surface 31 of the central contact 3 in the containable portion 23 of the case 2 to secure the downward stroke amount of the movable contact 5. With such a configuration, it is possible to increase the downward stroke amount of the movable contact 5 by the thickness of the central contact 3 and the depth of the concave portion 211. Therefore, even when the push switch 1 is miniaturized and its height is reduced, it is possible to secure a sufficient downward stroke amount of the movable contact 5, and thereby it is possible to provide a good click feeling to the user. Although the depth of the concave portion 211 is not particularly limited as long as it ensures a sufficient downward stroke amount of the movable contact 5 and provides a good click feeling to the user, in the present embodiment, the depth of the concave portion 211 (the distance from the upper surface of the bottom plate stepped portion 212 to the upper surface of the concave portion 211) is about 0.02 mm. In this connection, it is to be noted that the height of the wall portion 22 of the case 2 (the distance from the upper surface of the bottom plate stepped portion 212 or the contact surface 41 of the outer contact 4 to the upper surface of the wall portion 22) is about 0.14 mm.

Referring back to FIG. 4, the movable contact 5 is an elastic conductive member having an upwardly convex dome shape, and it is disposed in the containable portion 23 of the case 2 above the central contact 3 and the outer contact 4. The movable contact 5 has a planar shape that fits in the containable portion 23 of the case 2. Further, the corner portions of the movable contact 5 are R processed so as to be rounded. In this regard, although a degree of the R process with respect to the corner portions of the movable contact 5 is relatively small in the illustrated aspect, the present invention is not limited thereto. The scope of the present invention involves an aspect in which the degree of the R process with respect to the corner portions of the movable contact 5 is larger than that of the illustrated aspect so that the planar shape of the movable contact 5 becomes a substantially elliptic shape. The planar shape of the movable contact 5 in this case can be also considered as the substantially rectangular shape having the longer side direction and the shorter side direction. The movable contact 5 is configured so as to be displaceable between the first position in which the central contact 3 and the outer contact 4 are in the non-conductive state and the second position in which the central contact 3 and the outer contact 4 are in the conductive state.

The movable contact 5 has a central movable portion 51 which makes contact with the central contact 3, and an outer periphery portion 52 which makes contact with the outer contact 4. The central movable portion 51 is formed at a substantially center of the movable contact 5 in a plan view and the outer periphery portion 52 is formed so as to surround the central movable portion 51. As shown in FIG. 8 which is the longitudinal sectional view of the push switch 1, the movable contact 5 is provided in the containable portion 23 of the case 2 so that the central movable portion 51 is opposed via a gap against the contact surface 31 of the central contact 3 and the outer periphery portion 52 makes contact with the upper surface of the bottom plate stepped portion 212 of the bottom plate 21 of the case 2 and the contact surface 41 of the outer contact 4. That is, in a natural state in which the pressing force is not applied from the user to the push switch 1, the movable contact 5 is convex to the upper side. In the natural state shown in FIG. 8, the movable contact 5 takes the first position. When the movable contact 5 is in the first position, the movable contact 5 is not in contact with the central contact 3, while in contact with the outer contact 4. Therefore, when the movable contact 5 takes the first position, the central contact 3 and the outer contact 4 are in the non-conductive state.

In the natural state shown in FIG. 8, when the pressing force exceeding the operating force of the push switch 1 is applied to the pressing member 7, the pressing member 7 presses the movable contact 5 downward as shown in FIG. 9, and therefore the movable contact 5 is moved from the first position to the second position. When the movable contact 5 is in the second position, the outer periphery portion 52 is in contact with the upper surface of the bottom plate stepped portion 212 of the bottom plate 21 of the case 2 and the contact surface 41 of the outer contact 4, and further the central movable portion 51 is in contact with the contact surface 31 of the central contact 3. That is, when the movable contact 5 is in the second position, the movable contact 5 is in contact with both the central contact 3 and the outer contact 4. Therefore, when the movable contact 5 takes the second position, the movable contact 5 functions as a conduction path between the central contact 3 and the outer contact 4, and thus the central contact 3 and the outer contact 4 are in the conductive state. Specifically, in both the first position and the second position, the movable contact 5 is in contact with the outer contact 4. On the other hand, when the movable contact 5 takes the first position, the movable contact is not in contact with the central contact 3, but when movable contact takes the second position, the movable contact 5 is in contact with the central contact 3.

Referring back to FIG. 4, on the upper side of the movable contact 5, one or more intermediate movable members 6 are stacked. The one or more intermediate movable members 6 are a member disposed to overlap the upper side of the movable contact 5 in order to set the operating force of the push switch 1 to a predetermined value. Although the number of the intermediate movable members 6 is not particularly limited, in the present embodiment, the intermediate movable members 6 include three intermediate movable members 6a, 6b, 6c stacked in order from the top. The intermediate movable members 6a, 6b, 6c are provided between the movable contact 5 and the pressing member 7 in a stacked manner. Each of the intermediate movable members 6a, 6b, 6c is an elastic conductive member formed of the same conductive material as the movable contact 5 and further has an upwardly convex domed shape having the same shape as the movable contact 5. Therefore, the spring load of each of the intermediate movable members 6a, 6b, 6c and the spring load of the movable contact 5 are equal. In this connection, it should be noted that the language “the spring load of each of the intermediate movable members 6a, 6b, 6c and the spring load of the movable contact 5 are equal” includes the case that the difference between the spring load of each of the intermediate movable members 6a, 6b, 6c and the spring load of the movable contact 5 lies within the manufacturing tolerance occurring during the manufacture of the push switch 1 (for example, even if it is about a few percent) in addition to the case that the spring load of each of the intermediate movable members 6a, 6b, 6c and the spring load of the movable contact 5 are exactly equal to each other.

Further, similarly to the movable contact 5, each of the intermediate movable members 6a, 6b, 6c has a central movable portion 61 and an outer periphery portion 62. In this connection, it is to be noted that as described above, each of the intermediate movable members 6a, 6b, 6c and the movable contact 5 are formed of the same conductive material, but in order to improve the corrosion resistance and conductivity, only the surface of the movable contact 5 is subject to a plating treatment with a metal having high corrosion resistance and conductivity such as silver.

By arranging such intermediate movable members 6a, 6b, 6c on the movable contact 5 in a stacked manner, even when the movable contact 5 is miniaturized in accordance with miniaturization of the push switch 1, the operating force of the push switch 1 can be made equal to or greater than a predetermined value, for example, equal to or greater than 300 gf, and thereby malfunction of the push switch 1 can be prevented. The spring load of the movable contact 5 of each of the intermediate movable members 6a, 6b, 6c as well as the spring load of the cover film 8 described later are not particularly limited as long as they make it possible to keep the operating force of the push switch 1 to be a constant or more, for example, the spring load per one of the intermediate movable members 6a, 6b, 6c and the movable contact 5 is about 50 gf.

In this regard, by changing the material of the movable contact 5 and/or by increasing the curvature of the dome-shaped movable contact 5, it is possible to increase the spring load of the movable contact 5. However, in this case, the spring load of the movable contact 5 is immediately reduced when it is repeatedly elastically deformed. That is, the spring load and the life of the movable contact 5 are in a trade-off relationship, and thus when increasing the spring load of the movable contact 5, the life of the movable contact 5 is shortened. Therefore, from the viewpoint of the life of the push switch 1, namely from the viewpoint of securing the life of the push switch 1, it is not preferable to make the operating force of the push switch 1 to be a constant value or more by increasing the spring load of the movable contact 5.

On the other hand, by increasing the number of members providing the spring load (that is, the movable contact 5 and the intermediate movable members 6) so as to limit the magnitude of the spring load per sheet, a decrease of the life of each of the members providing the spring load can be suppressed, and thereby it is possible to suppress a decrease of the life of the push switch 1. Further, from the viewpoint of suppressing the decrease of the life of the push switch 1, the number of the intermediate movable members 6 is preferably three or more.

The pressing member 7 is provided in the containable portion 23 of the case 2 between the upper surface of the movable contact 5 and the lower surface of the cover film 8. More specifically, the pressing member 7 is held between the lower surface of the cover film 8 and the upper surface of the intermediate movable member 6. The pressing member 7 is used to effectively transmit the pressing force applied from the user to the push switch 1 through the intermediate movable members 6 to depress the movable contact 5 downward.

The pressing member 7 is a disk-shaped member formed of a resin material having a hardness higher than that of the resin material forming the cover film 8. By forming the pressing member 7 using such a resin material lighter than the metal material, it is possible to reduce the weight of the pressing member 7. By reducing the weight of the pressing member 7, when the push switch 1 is in a natural state, it is possible to reduce the downward bias force applied to the movable contact 5 and the intermediate movable members 6 by the weight of the pressing member 7, and thus it is possible to increase the operating force of the push switch 1.

As described in the column of the background art, with the miniaturization of the push switch 1, the movable contact 5 is also miniaturized. However, in order to make the operating force of the push switch 1 to be a certain level or more, the one or more intermediate movable members 6 are provided on the upper side of the movable contact 5, and thus the total spring load of the movable contact 5 and the intermediate movable members 6 which is pressed by the pressing member 7 is not reduced. Therefore, even when the push switch 1 is miniaturized, it is impossible to simply reduce the size of the pressing member 7 for pressing the movable contact 5 and the intermediate movable members 6.

If the size of the pressing member 7 for each of the intermediate movable members 6 and the movable contact 5 is too small, the pressing member 7 will collapse during pressing, and thus it is impossible to operate the push switch 1. On the other hand, if the size of the pressing member 7 for each of the movable contact 5 or the intermediate movable members 6 is too large, the pressing force applied to the movable contact 5 and the intermediate movable members 6 will be scattered, and thus it is impossible to provide a good click feeling to the user.

FIG. 7 shows a relationship between the size of the pressing member 7 and the size of the movable contact 5 in the push switch 1 of the present invention. FIG. 7 is a planner view of the pressing member 7 and the movable contact 5 viewed from the upper side in a state in which the push switch 1 is assembled. In this regard, it is to be noted that for simplicity of the drawings, components of the push switch 1 other than the pressing member 7 and the movable contact 5 are omitted in FIG. 7.

As shown in FIG. 7, a diameter R of the pressing member 7 is preferably in the range of 30 to 45% of the width W1 of the movable contact 5 in the longer side direction, more preferably in the range of 35 to 40% of the width W1. Further, the diameter R of the pressing member 7 is preferably in the range of 45 to 60% of the width W2 of the movable contact 5 in the shorter side direction, more preferably in the range of 50 to 55% of the width W2. By setting the size of the pressing member 7 so as to satisfy the above relationship, even when the push switch 1 is miniaturized, it is possible to provide a good click feeling to the user.

In this regard, it is to be noted that the width W1 in the longer side direction and the width W2 of the shorter side direction of the movable contact 5 (and the intermediate movable members 6) may be appropriately changed by the size of the required push switch 1. However, in the small push switch such as the push switch 1 of the present invention, the width W1 of the longer side direction of the movable contact 5 (or the intermediate movable member 6) is 1.80 mm or less, specifically, in the present embodiment, the width W1 of the longer side direction is about 1.52 mm. On the other hand, the width W2 of the shorter side direction of the movable contact 5 (or the intermediate movable member 6) is 1.20 mm or less, specifically, in the present embodiment, the width W2 is about 1.13 mm.

Referring back to FIG. 4, the cover film 8 is provided above the movable contact 5, the intermediate movable members 6 and the pressing member 7 so as to cover the containable portion 23 of the case 2. The cover film 8 is formed of a flexible resin material such as nylon, and is laser-welded to the upper surface of the wall portion 22 defining the containable portion 23 of the case 2 to liquid-tightly seal the containable portion 23. The cover film 8 includes a circular central portion 81 which is welded to the pressing member 7, an inclined portion 82 extending obliquely downward from the central portion 81, a peripheral portion 83 extending in the plane direction from the lower end of the inclined portion 82.

The lower surface of the central portion 81 is welded to the upper surface of the pressing member 7 by surface welding by laser welding. In the natural state shown in FIG. 8, the pressing member 7 is positioned in a space defined by the lower surface of the central portion 81 and the inner surface of the inclined portion 82. Since the peripheral portion 83 is welded to the upper surface of the wall portion 22 of the case 2 by laser welding, the containable portion 23 of the case 2 is sealed in a liquid-tight manner by the cover film 8. The laser welding of the cover film 8 with respect to the upper surface of the wall portion 22 of the case 2 is performed so as to be circumferentially welded to the upper surface of the wall portion 22 (rather than spot welding), thereby the containable portion 23 is sealed and thus waterproof and dustproof functions of the push switch 1 are realized.

The welding width between the periphery portion 83 of the cover film 8 and the upper surface of the wall portion 22 is not particularly limited as long as a sufficient adhesion force between the cover film 8 and the upper surface of the wall portion 22 can be secured, but is typically 0.1 to 0.2 mm. Further, since the cover film 8 is formed of a flexible resin material, it provides a spring load similarly to the movable contact 5 and the intermediate movable members 6. Furthermore, as shown in FIG. 8, the diameter of the central portion 81 is larger than the diameter R of the pressing member 7, and thus the inclined portion 82 extends obliquely downward from a portion spaced from the edge portion of the pressing member 7.

Next, with reference to FIGS. 8 and 9, the operation of the push switch 1 will be described in detail. FIG. 8 shows a longitudinal cross-sectional view of the push switch 1 in a natural state in which no pressing force is applied to the push switch 1. FIG. 9 shows a longitudinal cross-sectional view of the push switch 1 in a pressed state in which a pressing force exceeding the operating force of the push switch 1 is applied to the push switch 1.

As shown in FIG. 8, in the natural state of the push switch 1, each of the movable contact 5 and the intermediate movable members 6a, 6b, 6c is convex upward. In the state shown in FIG. 8, the movable contact 5 takes the first position. In the first position, the outer periphery portion 52 of the movable contact 5 is in contact with the contact surface 41 of the outer contact 4, but the central movable portion 51 of the movable contact 5 is not in contact with the contact surface 31 of the central contact 3. That is, when the movable contact 5 is in the first position, the movable contact 5 is not in contact with the central contact 3, but the movable contact 5 is in contact with the outer contact 4. Therefore, when the movable contact 5 is in the first position, the central contact 3 and the outer contact 4 is in a non-conductive state.

In the natural state shown in FIG. 8, when a pressing force exceeding the operating force of the push switch 1 is applied to the pressing member 7 through the cover film 8, the pressing member 7 presses the movable contact 5 and the intermediate movable members 6 downward to displace the movable contact 5 to the second position, and thus the push switch 1 shifts to the depressed state shown in FIG. 9.

In the depressed state shown in FIG. 9, the movable contact 5 takes the second position. In the second position, the outer periphery portion 52 of the movable contact 5 is in contact with the contact surface 41 of the outer contact 4, and the central movable portion 51 of the movable contact 5 is in contact with the contact surface 31 of the central contact 3. That is, when the movable contact 5 is in the second position, the movable contact 5 is in contact with both the central contact 3 and the outer contact 4. Therefore, when the movable contact 5 is in the second position, the movable contact 5 functions as a conduction path between the central contact 3 and the outer contact 4, and thus the central contact 3 and the outer contact 4 is in a conductive state. Further, in the containable portion 23 of the case 2, the contact surface 31 of the central contact 3 is in a lower position lower than the contact surface 41 of the outer contact 4. Therefore, when the movable contact 5 is in the second position, a portion of the central movable portion 51 of the movable contact 5 which is in contact with the contact surface 31 of the central contact 3 is in a lower position than a position of the outer periphery portion 52 of the movable contact 5 which is in contact with the contact surface 41 of the outer contact 4. Further, at this time, each of the intermediate movable members 6a, 6b, 6c is also in the depressed state, and thus the central movable portion 61 of each of the intermediate movable members 6a, 6b, 6c is depressed to a position lower than each of the outer periphery portion 62 thereof. This makes it possible to obtain a sufficient spring load while ensuring a good click feeling.

In the depressed state shown in FIG. 9, when the pressing force on the pressing member 7 is released, the push switch 1 is restored to the natural state shown in FIG. 8 by the restoring force of the push switch 1 provided by the elastic restoring force of the movable contact 5, the intermediate movable members 6 and the cover film 8.

In FIG. 10, the feeling curve of the push switch 1 (load characteristics) is shown. The vertical axis of the graph in FIG. 10 is a load applied to the pressing member 7 (pressing force) (gf or N), and the horizontal axis is the stroke amount of the pressing member 7 (moving distance downward) (mm). As shown in FIG. 10, until the load applied to the push switch 1 reaches the operating force applied to each of the movable contact 5 and the intermediate movable members 6a, 6b, 6c of the push switch 1, the load required to depress the pressing member 7 is gradually increased. When the load applied to the push switch 1 reaches the operating force applied to each of the movable contact 5 and the intermediate movable members 6a, 6b, 6c of the push switch 1, the load required to depress the pressing member 7 is rapidly decreased. Therefore, when the load applied to the push switch 1 reaches the operating force of the push switch 1, the pressing member 7 is suddenly depressed, and thereby a click feeling is provided to the user. Thereafter, when the application of the load to the pressing member is released, the pressing member 7 is pushed upward due to the respective restoring forces of the movable contact 5 and the intermediate movable member 6a, 6b, 6c of the push switch 1 at the time when the stroke of the pressing member 7 is completed. Then, the push switch 1 returns to the natural state.

Although the push switch of the present invention has been described above based on the illustrated embodiments, the present invention is not limited thereto. Each configuration of the present invention can be replaced with any configuration capable of performing the same function or any configuration can be added to each configuration of the present invention.

Those skilled in the art in the field and art to which this invention belongs will be able to make changes to the described push switch configuration of the present invention without significantly departing from the principles, concepts, and scope of this invention, and push switches having changed configurations are also involved within the scope of this invention.

In addition, the number and types of components of the push switch shown in FIGS. 3 to 9 are merely illustrative, and the present invention is not necessarily limited thereto. An aspect in which any component is added or combined or any component is omitted without departing from the principle and intent of the present invention is also involved within the scope of the present invention.

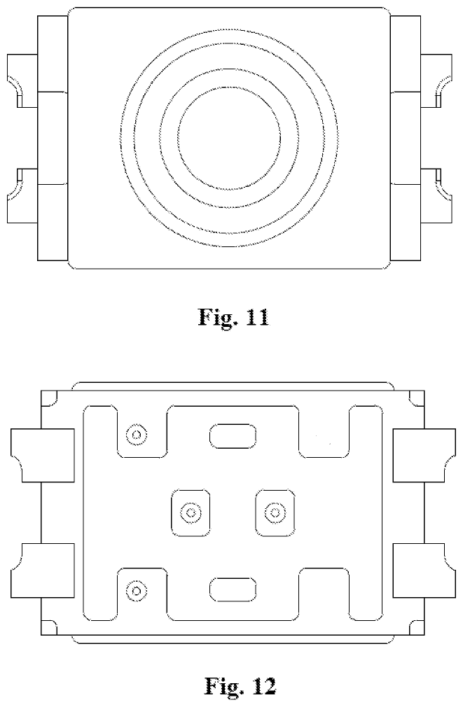

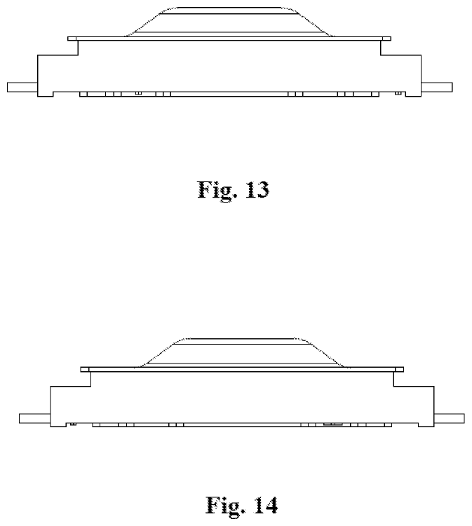

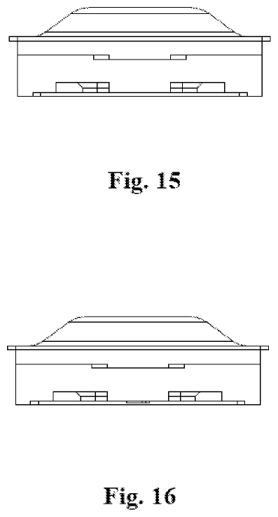

FIGS. 11 to 16 show six-sided views of the push switch according to the embodiment of the present invention for reference. FIG. 11 is a plan view of the push switch according to the embodiment of the present invention. FIG. 12 is a bottom view of the push switch according to the embodiment of the present invention. FIG. 13 is a front view of the push switch according to the embodiment of the present invention. FIG. 14 is a rear view of the push switch according to the embodiment of the present invention. FIG. 15 is a left side view of the push switch according to the embodiment of the present invention. FIG. 16 is a right side view of the push switch according to the embodiment of the present invention.

1. A push switch, comprising:
a case having a containable portion defined by a bottom plate and a wall portion extending upward from the bottom plate;
a central contact provided on the bottom plate in the containable portion;
an outer contact provided on the bottom plate in the containable portion so as to be spaced apart from the central contact;
a dome-shaped movable contact having a substantially rectangular and planner shape that can be displaced in the containable portion between a first position disposed above the central contact and the outer contact in which the central contact and the outer contact are in a non-conductive state and a second position in which the central contact and the outer contact are in a conductive state;
a cover film disposed above the movable contact so as to cover the containable portion; and
a disc-shaped pressing member disposed on the movable contact so as to displace the movable contact from the first position to the second position by pushing the movable contact downwardly,
wherein a diameter of the pressing member is in a range of 30 to 45% of a width of the movable contact in a longer side direction thereof in a planner view, and in a range of 45 to 60% of the width of the movable contact in a shorter side direction thereof in the planner view.

2. The push switch as claimed in claim 1, wherein the movable contact is in contact with the outer contact in both the first position and the second position, and when the movable contact takes the first position, the movable contact is not in contact with the central contact, but when the movable contact takes the second position, the movable contact is in contact with the central contact, and
wherein in the containable portion of the case, a contact surface of the central contact which is in contact with the movable contact when the movable contact takes the second position is located lower than a contact surface of the outer contact which is in contact with the movable contact.

3. The push switch as claimed in claim 2, wherein the bottom plate of the case has a concave portion formed in a substantially central portion of the bottom plate, and a bottom plate stepped portion located outside the concave portion, wherein an upper surface of the concave portion is lower than an upper surface of the bottom plate stepped portion.

4. The push switch as claimed in claim 3, wherein the central contact is embedded in the bottom plate of the case so that the contact surface of the central contact is a same height as the upper surface of the concave portion of the bottom plate of the case, and
wherein the outer contact is embedded in the bottom plate of the case so that the contact surface of the outer contact is the same height as the upper surface of the bottom plate stepped portion of the bottom plate.

5. The push switch as claimed in claim 1, wherein the cover film is welded to an upper surface of the wall portion of the containable portion of the case so as to seal the containable portion of the case in a liquid-tight manner.

6. The push switch as claimed in claim 1, further comprising one or more intermediate movable members provided between the movable contact and the pressing member, wherein each of the one or more intermediate movable members is made of a same material as the movable contact and has a same shape as the movable contact.

7. The push switch as claimed in claim 6, wherein a spring load of each of the one or more intermediate movable members is equal to a spring load of the movable contact.

8. A push switch, comprising:
a case having a containable portion defined by a bottom plate and a wall portion extending upward from the bottom plate;
a central contact provided on the bottom plate in the containable portion;
an outer contact provided on the bottom plate in the containable portion so as to be spaced apart from the central contact;
a dome-shaped movable contact having a substantially rectangular and planner shape that can be displaced in the containable portion between a first position disposed above the central contact and the outer contact in which the central contact and the outer contact are in a non-conductive state and a second position in which the central contact and the outer contact are in a conductive state;
a cover film disposed above the movable contact so as to cover the containable portion;
a disc-shaped pressing member disposed on the movable contact so as to displace the movable contact from the first position to the second position by pushing the movable contact downwardly; and
one or more intermediate movable members provided between the movable contact and the pressing member,
wherein a diameter of the pressing member is in a range of 30 to 45% of a width of the movable contact in a longer side direction thereof in a planner view, and in a range of 45 to 60% of the width of the movable contact in a shorter side direction thereof in the planner view.

9. The push switch as claimed in claim 8, wherein each of the one or more intermediate movable members is made of the same material as the movable contact and has the same shape as the movable contact,
the one or more intermediate movable members are stacked above the movable contact, and
each of the movable contact and the intermediate movable members has a central movable portion formed in a substantially central part thereof in a planner view and an outer periphery portion formed so as to surround the central movable portion.

10. The push switch as claimed in claim 9, wherein the outer periphery portion of the movable contact is in contact with the outer contact in both the first position and the second position, and when the movable contact takes the first position, the central movable portion of the movable contact is not in contact with the central contact, but when the movable contact takes the second position, the central movable portion of the movable contact is in contact with the central contact, and
wherein in the containable portion of the case, a contact surface of the central contact which is in contact with the central movable portion of the movable contact when the movable contact takes the second position is located lower than a contact surface of the outer contact which is in contact with the outer periphery portion of the movable contact, and
wherein when the movable contact is in the second position, the central movable portion of the intermediate movable member which is located at least the uppermost position among the intermediate movable members is located at a position lower than the outer periphery portion of the uppermost intermediate movable member.
